(19) United States
(12) Patent Application Publication
(10) Pub. No.: US 2022/0129903 A1
(43) Pub. Date: Apr. 28, 2022

(54) SYSTEM AND METHOD FOR AUTHENTICATION AND FRAUD DETECTION BASED ON IOT ENABLED DEVICES

(71) Applicant: JPMorgan Chase Bank, N.A., New York, NY (US)

(72) Inventors: Ankur SAMBHAR, Thane West (IN); Alex LIEBERMAN, Marlboro, NJ (US); Sarah N. MOGILL, Philadelphia, PA (US); Ryan Andrew SCHLOSSER, New York, NY (US)

(21) Appl. No.: 15/347,972

(22) Filed: Nov. 10, 2016

(51) Int. Cl. G06Q 20/40

(52) U.S. Cl. CPC G06Q 20/40145; G06Q 20/4012; G06Q 20/4016

(57) ABSTRACT

The invention relates to a customer authentication system that comprises: identifying a customer identification based on a customer input; using the customer identification, identifying a plurality of IoT devices associated with the customer where the customer has an authentication set of IoT devices; receiving a user selection of IoT devices; determining whether the user selection matches the authentication set of IoT devices; connecting to one or more of the user selected IoT devices; transmitting a request to one or more of the user selected IoT devices for user interaction data; and verifying user activity based on the user interaction data.

### FIELD OF THE INVENTION

The invention relates generally to a system and method for customer authentication and fraud detection, and more particularly to a system and method that determines authentication using a one-time PIN or other code, location data to confirm a user's location as well as data from Internet of Things (“IoT”) enabled devices that generate a unique IoT fingerprint.

### BACKGROUND OF THE INVENTION

Traditional user authentication is based on biometric validation or user entered credentials. This poses a serious security issue when user credentials are compromised. If a fraudster gains access to a user's ATM or online credentials, the fraudster will have access to a user's account and will have the ability to perform unauthorized transactions. Current systems are not able to leverage a complete digital ecosystem associated with the user to differentiate between a valid user and a fraudster.

These and other drawbacks currently exist.

### SUMMARY OF THE INVENTION

According to one embodiment, the invention relates to an authentication system that comprises: a memory that stores account data and interaction data associated with a customer; an interface that communicates with one or more IoT devices associated with the customer; and a computer processor, coupled to the memory and the interface. The computer processor is programmed to: determine a customer identification based on a customer input; using the customer identification, identify a plurality of IoT devices associated with the customer where the customer has an authentication set of IoT devices; receive a user selection of IoT devices; determine whether the user selection matches the authentication set of IoT devices; connect to one or more of the user selected IoT devices; transmit a request to one or more of the user selected IoT devices for user interaction data; and verify user activity based on the user interaction data.

The method may be conducted on a specially programmed computer system comprising one or more computer processors, mobile devices, electronic storage devices, and networks.

The invention also relates to method for customer authentication. The method comprises the steps of: determining, via an interface, a customer identification based on a customer input; using the customer identification, identifying a plurality of IoT devices associated with the customer where the customer has an authentication set of IoT devices; receiving, via the interface, a user selection of IoT devices; determining, via a computer processor, whether the user selection matches the authentication set of IoT devices; connecting, via a cloud connection, to one or more of the user selected IoT devices; transmitting, via the cloud connection, a request to one or more of the user selected IoT devices for user interaction data; and verifying user activity based on the user interaction data.

According to one embodiment, the invention relates to an authentication system that comprises: a memory that stores and manages account data and interaction data associated with a customer; an interface that communicates with one or more devices associated with the customer; and a computer processor, coupled to the memory and the interface. The computer processor is programmed to: receive a signal indicating an initiation of a transaction by the customer; generate a one-time PIN for the customer; transmit the one-time PIN to the customer; and authenticate the transaction upon receipt of the one-time PIN from the customer.

The computer implemented system, method and medium described herein provide the advantages of authentication using IoT devices, according to various embodiments of the invention. The innovative system and method provide multi-level security using location and IoT devices that generate a unique fingerprint that enhances security. Other advantages that can be provided are customer loyalty and retention due to the increased satisfaction of the account holder. The system provides convenience and security for customers as they transact with various financial devices with a branch location and/or other customer interfaces. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a schematic diagram of an authentication system, according to an exemplary embodiment.

FIG. 2 is an exemplary flowchart illustrating a OTP transaction, according to an embodiment of the present invention.

FIG. 3 is an exemplary flowchart illustrating location-based authentication, according to an embodiment of the present invention.

FIG. 4 is an exemplary system diagram of an IoT authentication system, according to an embodiment of the present invention.

FIG. 5 is an exemplary flowchart illustrating user authentication using IoT devices, according to an embodiment of the present invention.

FIG. 6 is an exemplary flowchart illustrating user authentication using IoT devices, according to an embodiment of the present invention.

FIG. 7 is an exemplary system diagram of an IoT authentication system, according to an embodiment of the present invention.

FIG. 8 is an exemplary flowchart illustrating user authentication using IoT devices, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to requiring a revolving one-time-PIN for certain transactions, such as ATM transactions, transactions over a predetermined amount, transactions at a merchant, geographic area, etc. For example, the system may require a one-time PIN for a transaction over a dollar threshold. In this example, the one-time PIN may be accessed via a mobile device, such as a smartphone, before a transaction. Also, the PIN may be pushed to a mobile device after the user initiates a transaction, e.g., after a card swipe.

An embodiment of the present invention may authenticate a user based on location confirmation. The system of an embodiment of the present invention may utilize a smartphone or other device with a location feature, such as a GPS. The location feature may be accessed when the user is conducting transactions. In this example, a push notification may activate a location feature or GPS function to the check or verify the location of an associated user device. When a transaction occurs in a physical store, the system may determine the store's location and then compare that to a location of an associated user device. The system may authenticate the transaction if the location of the store and the location of the user device matches. According to another example, for an online transaction, the system may utilize an IP address physical location and authorize the user's transaction based on whether the IP address matches a location of an associated user device.

According to another embodiment of the present invention, the system may utilize a specific channel, such as a cellular LTE channel, designed for transactions and a special hardware device (e.g., keyfob device, etc.) with a GPS (or other location feature) and access to a network. This embodiment of the present invention may include a passive solution that does not require additional action from the user.

For example, a special hardware keyfob may include a Near Field Communication (NFC) feature. NFC is based on communication protocols that enable electronic devices to communicate within a close proximity. According to an embodiment of the present invention, NFC functionality may be represented as a NFC tag with tokens to use for payment in the event a user device runs out of battery, power or is otherwise impaired. For example, the system may implement a payment system using a NFC keyfob device (e.g., with one-time-tokens or additional authentication via its use). The NFC tag may be written via a smartphone or other user device. For example, NFC tags may be overwritten by another NFC. In other words, a NFC tag may be written over by an app in mobile device via NFC methods.

An embodiment of the present invention is directed to user authentication that incorporates a fingerprint generated based on the user's IoT enabled devices. The IoT based fingerprint may be used alone and/or with a user's biometric, credentials and/or other form of identification. The system may verify the IoT based fingerprint and then enable the user to proceed with a transaction.

Internet of Things (“IoT”) devices may represent a network of physical devices or objects, vehicles, connected devices, smart devices, buildings and other items that may be embedded with electronics, software, sensors, actuators, and network connectivity that enable these objects to collect and exchange data. IoT technology allows objects to be sensed and/or controlled remotely across existing network infrastructure. Each IoT device may be uniquely identifiable through an embedded computing system and may be able to interoperate within an existing Internet infrastructure.

According to an embodiment of the present invention, a user may identify and associate a plurality of IoT enabled devices (e.g., car, laptop, workstation, television, refrigerator, etc.) with the user's account. The user may further specify a minimum number of devices to be used for generating the IoT based fingerprint. For example, the user may identify and associate five devices to the account and then specify three devices for the fingerprint generation process. Accordingly, the system may require at least 3 out of the 5 associated devices to participate in the authentication process by contributing to the fingerprint. The system may also automatically identify a required number of devices and/or other user input. For example, for high risk transactions, the system may require four or more IoT devices. For suspicious transactions, the customer may be further required to identify a specific order and/or other follow-up input from the user. And, for lower risk transactions, the system may require at least two IoT devices. The requirement may vary based on transaction type, amount, merchant location, risk level and/or other considerations and factors.

When a user attempts to access a secure account that requires authentication, the system may verify the user's identity through a known biometric, user credentials and/or any other authentication method based on one or more user inputs. Once the user is identified based on the user entered information (e.g., credentials, biometric, etc.), the system may prompt the user to specify the IoT devices to be used for the authentication. Based on the user specified choice of devices, the system may connect with those devices and transmit the user captured details. Each device may verify user interaction within a recent predetermined period of time, or last interaction event. For example, a device may verify whether the specified user had logged on that given device in last 24 hours using the given biometric details. The time period may be configurable, variable, predetermined, event-based, etc. Accordingly, if the user specifies “laptop” as one of the devices, the “laptop” may provide a required hash if the user had logged-in on that laptop in last 24 hours. If yes, the device may create a hash using its unique attribute, e.g., MAC address, static IP address, HD serial number, etc. For example, a hash value may be a number generated from a string of text. In general, hashing involves transforming a string of characters into a usually shorter fixed-length value or key that represents the original string.

According to an embodiment of the present invention, each device may create a hash and a single hash may be created out of a combination of each device hash. The system may also use a similar or corresponding to a multi-level verification that requires a function, M-of-N, to validate the user. M-of-N may represent the number of keys needed to verify a transaction.

The system of an embodiment of the present invention may verify whether the combined signature is valid and then authenticate the user based on the verification. Accordingly, for an unauthorized access to a user's account, a fraudster will need to break through each of the devices associated with the account in a short span of time, such as 24 hours. If a user changes any of its device, e.g., television, user may deactivate the old device and then add the new device with its account for authentication.

The various embodiments of the present invention provide multi-level authentication thereby enhancing security to a user's account through a multi-layered protection. With the system of an embodiment of the present invention, compromising one or few devices will not make the user's account vulnerable. The system strengthens security through multi-level authentication but does not require the user to remember multiple passwords. The innovative system provides ease of use for the user as the user only needs to specify the name of the devices to be used for the authentication. Moreover, only a valid user will know the devices that has been used in last 24 hours and will only specify those to be used in the authentication process.

An embodiment of the present invention is directed to user identification and/or authentication by leveraging a user's IoT enabled devices at various location. An embodiment of the present invention may use a user's associated IoT devices to verify and/or confirm the user's identity and further detect potential fraudulent uses. While authenticating the user, the system may connect to user-specified IoT enabled devices and based on the inputs from various devices, the system may determine whether the user is actually the one carrying out the transaction. For example, the system may send a request to each of the devices to provide user details along with device location. As part of the response, each device may determine whether the user is in the vicinity of the device. If the user is in the vicinity of the device, the device may respond back to the system confirming the user's presence in the vicinity of the device. But if the device does not find the user in the vicinity, the device may respond back to the system with the details of the last time the user was in device's vicinity. Using these details, the system may then determine and/or confirm the authenticity of the user.

For example, a user may access an account at an ATM. Upon user identification, the system may send a request to the user's car to verify user location. In this example, the user's associated car (or other device) may confirm whether the user is at a location near the ATM. If not, system may use other devices to verify the user's current location near the ATM. In addition, the system may send a request to the user's IoT enabled devices at home, office, temporary residence and/or other locations to determine whether the user is around any of those locations and/or whether the user was at those locations recently. For example, a home refrigerator may confirm that the user had operated it physically 10 mins ago. However, the user's home is at least 30 mins drive away from the ATM location. Accordingly, the system may recognize that it would not be possible for user to be at the current ATM given the user's recent interaction at a distant location. The transaction may then be denied or the system may be notified of a potential fraud.

Based on the information collected from various user devices, system may determine the authenticity of the user. If the system recognizes suspicious activity, a subsequent round of verification may be initiated. According to another example, the system may lock out the account for a pre-configured time (e.g., 30 minutes, etc.). In addition, the system may notify the user in real-time about the fraud attempt and may force the user to change the credentials. Other actions may be taken.

The various features of an embodiment of the present invention may provide enhanced security by leveraging the real-time user details from a user's own IoT ecosystem. The system may improve fraud prevention even if user credentials are compromised.

While the exemplary illustrations are directed to a user authentication in a financial institution, the various embodiments of the present invention may be applied to various industries that require user authentication.

The following descriptions provide different configurations and features according to exemplary embodiments. These configurations and features may relate to providing user authentication services. While certain nomenclature and types of applications/hardware are described, other names and application/hardware usage is possible and the nomenclature provided is done so by way of non-limiting examples only. Further, while particular embodiments are described, it should be appreciated that the features and functions of each embodiment may be combined in any combination as is within the capability of one of ordinary skill in the art. The figures provide additional exemplary details regarding the present invention. It should also be appreciated that these exemplary embodiments are provided as non-limiting examples only.

Various exemplary methods are provided by way of example herein. These methods are exemplary as there are a variety of ways to carry out methods according to the present disclosure. The methods depicted and described can be executed or otherwise performed by one or a combination of various systems and modules. Each block shown in the methods represents one or more processes, decisions, methods or subroutines carried out in the exemplary method, and these processes, decisions, methods or subroutines are not necessarily carried out in the specific order outlined in the methods, nor is each of them required.

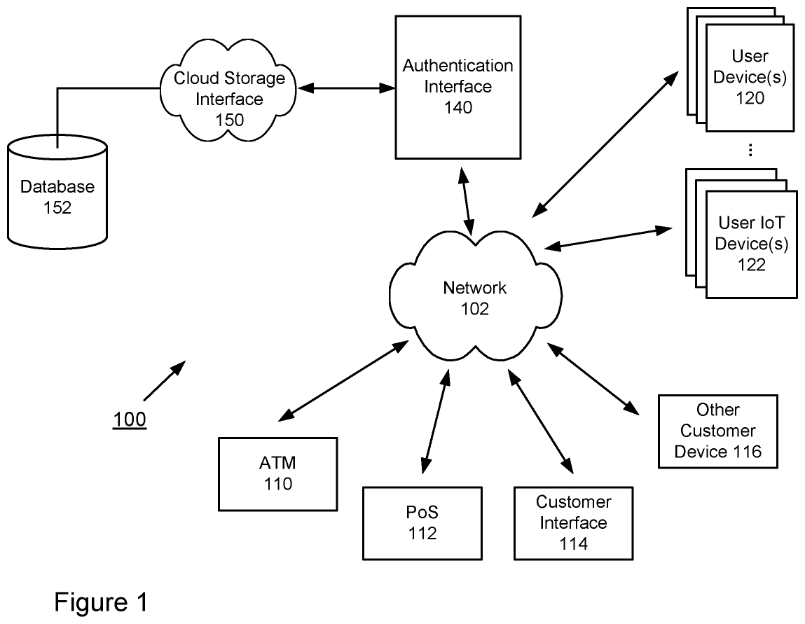

FIG. 1 illustrates a schematic diagram of an authentication system, according to an exemplary embodiment. As illustrated, network 102 may be communicatively coupled with one or more data devices including, for example, financial transaction machine 110, Point of Sale (PoS) terminal 112, Customer Interface 114 and/or other customer devices, represented by 116. Financial transaction machines represented by 110 may be fully automated devices, such as Automated Teller Machines (ATMs). User devices may include mobile device 120, which represents mobile phones, smart devices, smartwatch, smart glasses, other wearables, tablets, other computing devices capable of sending and/or receiving network signals and/or data, etc. Device 120 may have an application installed that is associated with the financial institution.

User IoT Device 122 may represent various IoT devices associated with the user. IoT devices may include devices, appliances, automobiles, home control devices and/or any device capable of sending and/or receiving network signals and/or data. IoT devices may include entrance portals (e.g., security devices that grant or deny access, etc.). IoT devices may include devices in common or public areas, e.g., hotel lobby, airport, tolls, etc. For example, a user may check-in at a hotel or enter a hotel room with an authorized room key. This information may be used to confirm user authentication in a local area.

Network 102 may communicate with an Authentication Interface 140 that identifies and/or authenticates users. Authentication Interface 140 may be coupled to a cloud storage interface 150 that stores data in a remote location, as illustrated by Database 152. The system 100 of FIG. 1 may be implemented in a variety of ways. Architecture within system 100 may be implemented as hardware components (e.g., module) within one or more network elements. It should also be appreciated that architecture within system 100 may be implemented in computer executable software (e.g., on a tangible, non-transitory computer-readable medium) located within one or more network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 is depicted, it should be appreciated that other connections and relationships are possible. The system 100 described below may be used to implement the various methods herein, by way of example. Various elements of the system 100 may be referenced in explaining the exemplary methods described herein.

The network 102 may be a wireless network, a wired network or any combination of wireless network and wired network. For example, the network 102 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, the network 102 may support an Internet network, a wireless communication network, a cellular network, Bluetooth, or the like, or any combination thereof. The network 102 may further include one, or any number of the exemplary types of networks mentioned above operating as a stand-alone network or in cooperation with each other. The network 102 may utilize one or more protocols of one or more network elements to which it is communicatively coupled. The network 102 may translate to or from other protocols to one or more protocols of network devices. Although the network 102 is depicted as one network for simplicity, it should be appreciated that according to one or more embodiments, the network 102 may comprise a plurality of interconnected networks, such as, for example, a service provider network, the Internet, a cellular network, corporate networks, or even home networks, or any of the types of networks mentioned above.

Data may be transmitted and received via network 102 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

While FIG. 1 illustrates individual devices or components, it should be appreciated that there may be several of such devices to carry out the various exemplary embodiments. For example, the financial transaction device 110 may represent several EBKs, any one of which may be used to practice the various exemplary embodiments. Again, the use of EBKs is meant to be non-limiting and, may include, but are not limited to, automated teller machines (“ATMs”), personal teller machines (“PTMs”), financial self-service devices, financial services kiosks, financial transaction devices, portable electronic devices, money machines, cash machines, bank machines, and bancomats, for example. The financial transaction device 110 may be associated with and/or operated by a financial institution. The financial transaction machine may be connected directly with the financial institution, or indirectly using a payment network, processor, or gateway. The financial transaction machine 110 may also include a reader (e.g., NFC, BLE, WiFi, LTE, etc.) to establish wireless communication with mobile devices. Other forms of wireless, contactless and radio communications may be supported.

Authentication Interface 140 may perform operations associated with processing information and data associated with customer identification, authentication and fraud detection. Authentication Interface 140 may comprise one or more servers and/or computers, each having one or more computer processors associated therewith. In various exemplary embodiments, the Authentication Interface 140 may be a specific computing device to support exemplary embodiments as described herein.

Authentication Interface 140 may be communicatively coupled to Cloud Storage Interface 150 and Database 152. Database 152 may contain data and information used by the system 100. For example, Database 152 may store account data for customers as well as customer profile data. Database 152 may also contain additional information related to the operation and administration of the system 100. Database 152 may include any suitable data structure to maintain the information and allow access and retrieval of the information. For example, Database 152 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein.

Database 152 may be any suitable storage device or devices. The storage may be local, remote, or a combination thereof with respect to Database 152. Database 152 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). Database 152 may have back-up capability built-in. Communications with Database 152 may be over a network, such as network 102, or communications may involve a direct connection between Database 152 and Authentication Interface 140, as depicted in FIG. 1.

Having described an example of the hardware, software, and data that can be used to run the system, an example of the method and customer experience will now be described. The method will be described primarily as an example in which a customer downloads a software application (sometimes referred to as an “app”) and uses it to perform banking transactions and/or other functionality, including making purchases. However, those skilled in the art will appreciate that the principles of the invention can be applied to related circumstances, such as where the entity providing the app is a business other than a merchant, or where the merchant app functionality is provided through a browser on the customer's mobile device rather than through a software application (app) downloaded to the customer's mobile device, and with purchases from various providers.

According to an exemplary embodiment of the present invention, a payment instrument (e.g., payment card, credit card, etc.) may require a revolving One-Time-PIN for access and certain transactions. For example, the system may require a OTP for a transaction that involves withdrawing funds, e.g., ATM transaction, etc. An embodiment of the present invention is directed to a One Time Pin which may be used with other codes, including a One Time Security Code, Merchant Specific Security Code, etc.

Using credit, debit, or other account identifiers that are static, an embodiment of the present invention is directed to a static PIN and static security code for transactions above a certain threshold. The customer may set a threshold and/or condition for the system to be used, or the system may mandate a specific threshold and/or condition for the system to be used. For example, a customer may use a particular IoT device and/or blacklists and/or whitelists and/or OTP and/or OTSC if any transaction is over $100, but use a static for any transaction below this amount. Each system, IoT, blacklist/whitelist, OTP, and OTSC may be internally configured based on rules of amounts, locations, times, etc.

A user may specify various conditions, such as dollar amount threshold, merchant specific conditions, specific location restrictions, valid transaction time period, and/or restrictions or triggers etc. For such transactions, the user may be required to request a specific OTP (One Time Pin) for in-person purchases or OTSC (One Time Security Code) for online purchases.

For example, an OTP can be activated automatically in certain conditions when used with location features, such as GPS technology, to identify presence in a store or other merchant location. According to another example, the OTP may be requested via an app before a purchase is made. Also, the OTP may be provided during an un-cleared transaction as a push notification when a payment instrument is initiated (e.g., a card is swiped) and sent with a static PIN for a non-authorized transaction.

When making purchases, a QR code or other merchant identifying code may be used in conjunction with the request for an OTP to ensure that the card is being used at a proper location. For example, a code may be requested by a user's pre-registered device or from a user's financial account portal accessible on any device with proper connectivity.

The system may recognize whether a user is traveling out of region (or country) and may automatically disable the PIN feature. Also, the system may prompt the user with an option to disable the PIN feature—due to connectivity issues. For example, trip monitoring may be performed through email, customer notifications (e.g., phone calls, branch visits, etc.), or other mechanisms.

The OTP may be initiated via an app before the transaction—or after the user has swiped and it sends a notification to the phone (out of band channel)—before the user is presented with an entry screen.

According to an embodiment of the present invention, a OTSC may be used for online purchases. In this example, the user may open an app on a smartphone or other mobile device and request a OTSC. The OTSC code may be Time Sensitive, Amount Specific, Vendor Specific, and/or other combination or variation. The OTSC code may also be subscription based to a Specific Vendor and/or a Specific Amount and/or a Specific Time Frame of Subscription. The OTSC may be initiated by scanning a machine readable code on a checkout page. Other forms of user interaction may be realized.

An embodiment of the present invention may utilize GPS networks and last available transaction data to be confirm location accuracy within a time distance from the last transaction. Also, if a transaction is transportation based, the system may identify a location that the user is headed and thereby update the location to the destination location if location or GPS functionality is not available. A transportation based transaction may refer to a payment for a taxi, bus, automotive vehicle, self-driving vehicle, or any other mode of transportation with a destination. For example, a user's mobile device may include an app that requests a car service with an intended destination. According to an embodiment of the present invention, the system may recognize a transaction area with an anticipated entry and exit, such as a tunnel, bridge, plane flight with intended destination, etc.

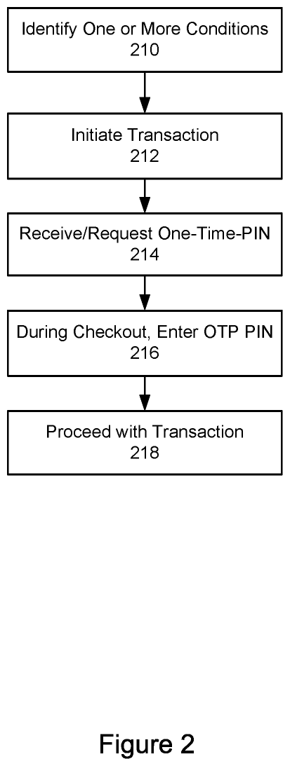

FIG. 2 is an exemplary flowchart illustrating a OTP/OTSC transaction, according to an embodiment of the present invention. At step 210, one or more conditions may be identified. At step 212, the user may initiate a transaction. At step 214, the user may receive or request a one-time-PIN for the transaction. At step 216, during checkout, the user may enter the OTP/OTSC. At step 218, the user may be authorized to proceed with the transaction. The order illustrated in FIG. 2 is merely exemplary. While the process of FIG. 2 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

According to an exemplary scenario, a user may identify one or more conditions, at step 210. For example, the user may set a payment instrument (e.g., card, etc.) to require an OTP/OTSC for transactions over $500. Other conditions may include additional security for transactions at certain merchants, transaction types (e.g., financial institution related transactions, withdrawals, actions, etc.), and/or other scenarios and applications. The conditions may be revised based on prior transaction, events, user-defined conditions, etc.

At step 212, the user may initiate a transaction. The transaction may be in-person at a merchant location, on-line via a website and/or other form of interaction. For example, the user may enter an electronic merchant store to make a purchase over $1000.

At step 214, the user may receive/request a OTP/OTSC. For example, the user may open an app on a mobile device to receive and/or request a OTP/OTSC that is active for a predetermined period of time, e.g., 15 minutes, 30 minutes. Also, the user may use a location feature (e.g., GPS, etc.) to request a merchant based OTP/OTSC. According to another example, the user may be issued a OTP/OTSC automatically, as part of the transaction.

At step 216, during a check-out process, the user may enter the OTP at a merchant point of sale device. Also, the user may enter the OTSC via a website or other online interface. According to another scenario, the user may enter a static code and be declined because of the transaction limit. In this scenario, the user may receive a push notification including an OTP/OTSC. At this stage, the dollar amount and merchant information may be received by the system (e.g., provider) and then authorized.

The features of an embodiment of the present invention may be provided via a subscription based service as well as non-subscription based service. In a subscription-based service, a merchant specific security code may be automatically registered and entered. In a non-subscription based service, a OTP/OTSC may be requested and entered online for certain dollar thresholds. An embodiment of the present invention may also provide additional safeguards. For example, a user may request a keychain, fob, etc., with a barcode or QR code to authorize the transaction in the case that a phone is absent, battery drained, without internet, etc.

The various embodiments of the present invention provide enhanced and improved security benefits. Users may also benefit from additional rewards after using their card with the OTP/OTSC function enabled. In this scenario, a user may receive an extra 0.5% cash back for such purchases. Accordingly, customer may benefit from subscribing to additional and enhanced security features, and the provider (e.g., bank, financial institution, merchant, etc.) may benefit from lower risk of fraud and card misuse. In addition, through use of GPS location monitoring for the issuance of Merchant-Specific Codes, users may also receive special deal notices through push notifications, emails, texts, or other mechanisms.

An embodiment of the present invention is directed to utilizing an additional source of information, which may be provided by associated and/or relevant devices. The additional source of information may include IoT devices, location-based features, one-time-PIN and/or customer map restrictions for approval for enhanced security. According to an exemplary illustration, this feature may be applied when a user engages with an ATM device. Other scenarios and applications involving user authentication may be realized.

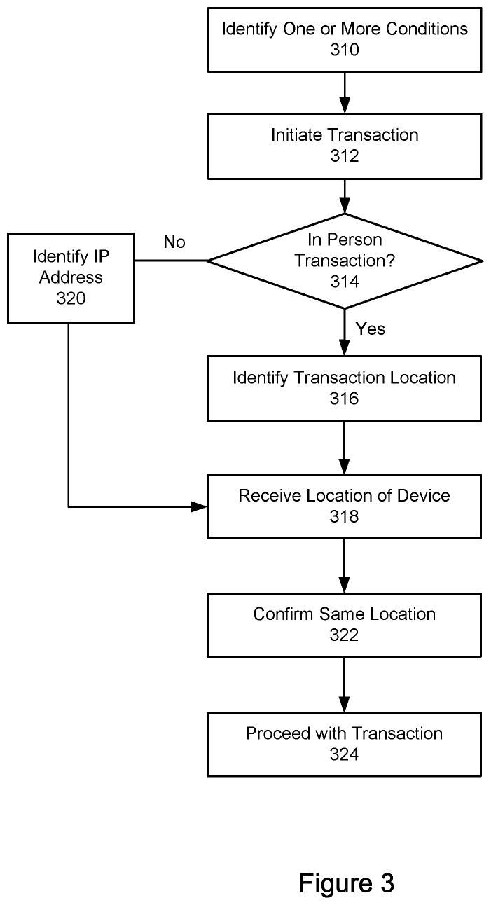

FIG. 3 is an exemplary flowchart illustrating location-based authentication, according to an embodiment of the present invention. At step 310, one or more conditions may be identified. At step 312, the user may initiate a transaction. At step 314, the system may determine whether the transaction is in-person, on-line or other form of transaction. At step 316, the system may identify transaction location. At step 318, user device location may be received. If the transaction is online, an IP address may be identified at step 320. At step 322, the system may determine or confirm that the location of the transaction and the location of the user device is a match. At step 324, the user may be authorized to proceed with the transaction. The order illustrated in FIG. 3 is merely exemplary. While the process of FIG. 3 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

At step 310, a user specify one or more conditions for additional security/authentication. For example, a customer may require an OTP for some or all ATM transactions, where the amount and specific transaction may or may not be pre-built into the PIN. The customer may also place restrictions and/or requirements based on transaction amount, merchant, transaction type, location, time period, etc.

Accordingly, a user may have control over various restrictions. In an exemplary embodiment involving ATM transactions, the user may identify ATM restrictions (e.g., whitelist, blacklist, etc.). Therefore, the user may specifically allow their card to be good at approved specific ATMs (e.g., work, home, other known locations, etc.)—and changes and/or any deviations from the approved list may be used to notify the customer, deny access, perform other safety measures, etc. For example, the system may recognize that the user does not travel to certain locations and accordingly, any transactions in those areas may be denied. In addition, the system may recognize approved areas and un-traveled areas and thereby automatically determine approved areas and unapproved areas based-on travel history, and location data. The system may identify such areas based on historical location data, real-time location data, prediction analysis, concurrent transactions (e.g., hotel reservations, airline purchases, gas and other purchases along a travel route, etc.). According to another embodiment, the various systems described herein may apply a blacklist/whitelist that is customer specific and/or based on other restrictions or factors.

At step 312, the user may initiate a transaction—which may be in-person, online, etc. The system may determine whether the transaction is in-person, at step 314. An in-person transaction may include a merchant store, ATM transaction and/or other card-present customer interaction.

At step 316, the system may identify the transaction location. For example, the customer may request $500 dollars from ATM X at Location Y (this location may be specified by GPS or other location functionality). In addition, the user may receive a PIN or other code to enter with their card into the ATM.

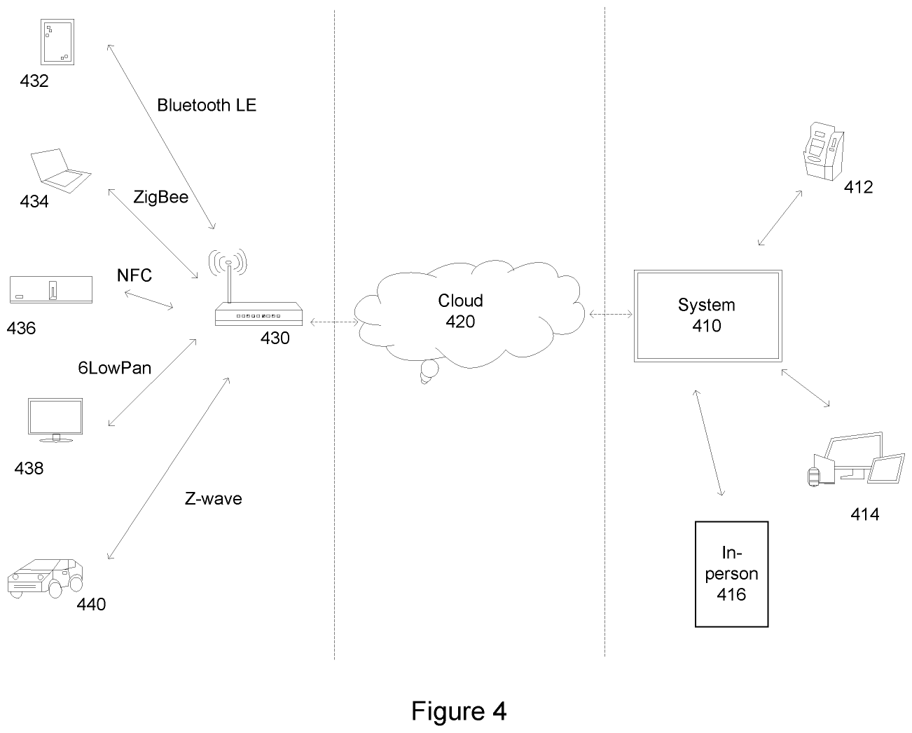

At step 318, the system may receive location of an associated user device. This may be achieved through a location feature, e.g., GPS, or other location-based functionality. If GPS is not available, the user may select a location and/or provide specific ATM details via a map in a mobile app or via other input for the transaction to occur. The device may represent one or more IoT devices, as explained in further detail below in connection with FIGS. 4-8.

The system may confirm that the location of the transaction and the location of the user device matches, at step 322. Accordingly, the transaction may proceed, at step 324. With the proper authentication, the ATM may proceed with the transaction.

According to another example, a user may require a threshold for OTP and use a static PIN for ATM transactions below this threshold.

The system may also include an emergency feature. For example, if there is an emergency to access an ATM beyond the restricted list, the system may apply an emergency layer of X dollars (e.g., one time transaction, periodic based) from any ATM. In this example, the system may accept withdrawals or transactions of $200 one time per week from any ATM. The user may also require conditions, where the conditions may pertain to requiring a OTP and/or calling a provider directly for approval to access this emergency layer or any other number of conditions built into the system.

FIG. 4 is an exemplary system diagram of an IoT authentication system, according to an embodiment of the present invention. As shown in FIG. 4, System 410 may represent a Provider or other Entity with service portals. In an exemplary embodiment involving a bank or financial institution, System 410 may provide ATMs, as shown by 412, online banking services, as shown by 414, in-person interface, as shown by 416, etc. System 410 may receive status information from various devices associated with the user, via a network, such as a Cloud Network 420. User devices may communicate via various forms of wireless communication, as shown by 430. Such user devices may include mobile devices 432, laptop 434, speaker 436, electronics 438, automobiles 440, etc.

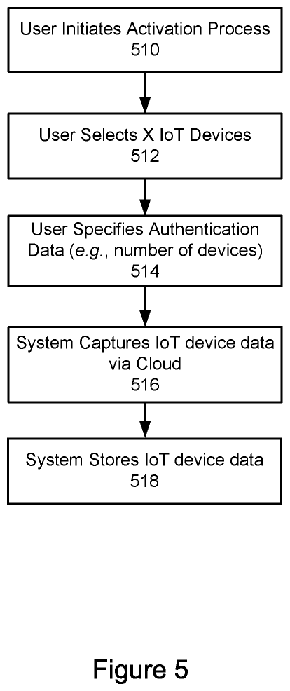

FIG. 5 is an exemplary flowchart illustrating user authentication using IoT devices, according to an embodiment of the present invention. At step 510, a user may initiate an activation process. At step 512, the user may select a plurality of IoT devices for association with the user's account. At step 514, the user may specify authentication data and/or conditions. This may involve a minimum number of devices for authentication. At step 516, the system may capture IoT device data via a network connection. At step 518, the IoT data may be stored by the system. The order illustrated in FIG. 5 is merely exemplary. While the process of FIG. 5 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

At step 510, a user may initiate an activation process. The activation process may involve selecting an option for associating IoT enabled devices. The user may identify one or more IoT devices for association with the user's account. IoT devices may include devices at home, office, etc. According to another example, the user may identify a home control device, which may then identify associated IoT devices for the user to select from.

At step 512, the user may select a number devices from an available list, which may include car, computer devices, laptop, desktop, tablets, televisions, game consoles, refrigerator, lighting devices, home thermometer control, access devices (e.g., home security system, garage door opener, front door keypad, etc.) and/or other IoT devices.

At step 514, the user may specify a minimum number of devices to be used for authentication. For example, a user may require three authentication devices. In this example, system will require a confirmation of at least three devices to authenticate user. User may choose any three devices from a given set of seven devices that are associated with users account to carry out a transaction. For example, the user may specify (1) automobile; (2) refrigerator, and (3) home computer.

At step 516, the system may capture IoT device data from a network connection, such as a cloud connection. For example, a bank system may capture a unique hash from the connected devices. The bank system may leverage the mobile app installed on user's mobile device. For example, the mobile app may communicate with the mentioned devices using wireless communications, such as Bluetooth, Bluetooth LE, NFC, 6LowPan, ZigBee, etc. to capture the required connection details. This may allow the bank system to communicate with the one or more devices over the Cloud. As shown by step 516, the captured details may be provided back to the bank system. The bank system may then use the connection details to communicate with the mentioned devices over the Cloud.

At step 518, the IoT data may be stored by the system. The data may be used to identify trends, make recommendations and/or perform other analysis.

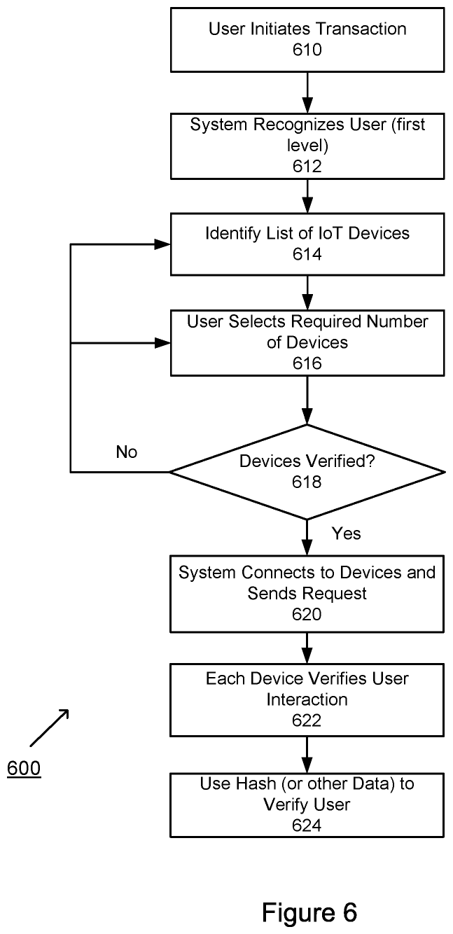

FIG. 6 is an exemplary flowchart illustrating user authentication using IoT devices, according to an embodiment of the present invention. At step 610, a user may initiate a transaction. At step 612, the system may recognize the user. At step 614, the system may identify a list of IoT devices to generate a unique fingerprint. At step 616, the user may select a required number of devices. At step 618, the system may verify the devices. If the devices are verified, the system may connect with the identified devices and request data, at step 620. If not, the system may re-engage the user, at step 614 or step 616. If potential fraud is detected, the system may initiate a fraud action. At step 622, each device may verify a last log-in or other user interaction. At step 624, the system may use device data to verify the user. The order illustrated in FIG. 6 is merely exemplary. While the process of FIG. 6 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

At step 610, a user may initiate a transaction. The transaction may include a merchant location, service provider, financial institution, online transaction, etc. For example, the user may enter an ATM or login to bank portal to carry out a transaction. The user may also initiate an interaction for access or other action. The description is not limited to transactions but may include other forms of access, authentication, verification, etc.

At step 612, the ATM machine and/or system may recognize the user. This may involve an initial level of user identification through a biometric verification, user credentials, user identifier, password, associated payment instrument, card instrument, etc. According to another embodiment of the present invention, this initial user identification may be optional.

At step 614, the bank system may identify a list of IoT devices. For example, the system may provide a list of IoT enabled devices associated with the user on a user display. In this example, the user may select using a touchscreen or other input. Other forms of interaction and input may be implemented. For example, the user may proactively identify a group of IoT devices. According to another example, the system may also identify IoT devices that are not specific to the user. These devices may be public or semi-public devices that the user has interacted with, such devices may include devices at airports, car rentals, taxis, hotels, other travel-type areas, government buildings, etc.

At step 616, the user may select a required predetermined number of devices for the available options. For example, user may select 4 devices, such as a car, laptop, television and refrigerator. User may select only the required number of devices for the devices which the user has listed with the account. The system may require variations based on the user associated IoT devices. For example, the system may also require a predetermined order of devices for user authentication. In this example, the system may require a combination of three devices in a particular order. According to another example, the system may require more devices, e.g., four devices, but an order may not be required. Also, the system may require a combination of IoT devices from different locations, in order words, the system may not accept devices all from the user's home. Based on a risk level and/or other data, the system may require more detailed information and/or a higher number of IoT devices for authentication. For lower risk and/or routine interactions, the system may ask for less detailed IoT input, or a lower number of IoT devices, for example. In addition, the user may designate one device as a device that is not part of the authentication so that when the device is selected, the system is alerted that the interaction is a fraudulent (or the customer is under duress and is signaling for assistance). Other variations of user input may be specified.

At step 618, the system may verify that the selected devices are associated with user's profile. If not, the system may allow the user to try again. If yes, the system may connect to the devices and transmit requests, at step 620. For example, the system may access details (e.g., device identifier, IP address, authentication details, etc.) to connect to those devices over a network connection, e.g., a Cloud connection, through authentication. For example, a Cloud connection may identify the device using the device identifier and may send a corresponding request to an appropriate sensor network using gateways and/or other components.

At step 622, each device may verify user interaction. This may involve verifying a last log-in within a predetermined period of time, e.g., whether user logged-on, activated and/or other interacted with the device in last 24 hours (or other time period). A device may verify other data as well, including last interaction, type of interaction, other associated actions with other devices, etc. Each device may provide interaction data, via a hash or other response.

At step 624, upon a successful verification of user, the given device may provide a response (e.g., a required hash) to the Cloud which may then respond back to the system. For example, a hash may be generated using a custom hardware installed on the device or it may be any unique serial number of the device (e.g., a car's engine number, chassis number, television display's serial number, etc.) Also, a bank system may use the hashes provided by each of the user selected devices to verify the user. The bank system may store the device's unique hash in its own data store for verification. Another option is to generate the required unique hash for each device and assign to it at the time of activating the device with the account. Accordingly, upon successful authentication, the user may perform a transaction on a given banking platform/system. Other types of response data and/or secured data may be implemented.

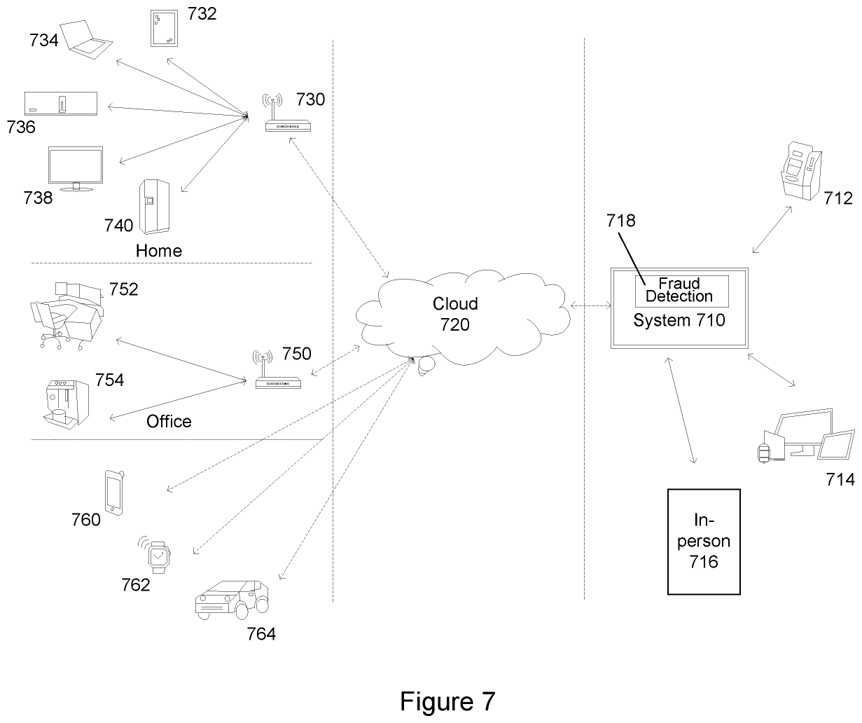

FIG. 7 is an exemplary system diagram of an IoT authentication system, according to an embodiment of the present invention. As shown in FIG. 7, System 710 may represent a Provider or other Entity with service portals. In an exemplary embodiment involving a bank or financial institution, System 710 may provide ATMs, as shown by 712, online banking services, as shown by 714, in-person interface, as shown by 716, etc. System 710 may include a Fraud Detection Processor, represented by 718. System 710 may receive status information from various devices associated with the user, via a network, such as a Cloud Network 720. User devices may communicate via various forms of wireless communication, as shown by 730, 750. User devices may be associated with certain locations, such as Home, Office, etc. Home devices may include mobile devices 732, laptop 734, speaker 736, electronics 738, home appliances 740, etc. Office devices may include desktop 752, office appliances 754. Office devices may also include access key pads (e.g., entrance ways), elevators, front desk, parking garage entrance/exit, etc. Other user devices may include user mobile device, such as smart phone 760, smart watch 762, automobile 764, etc. Other devices may include public devices, including transportation services, hotels, etc.

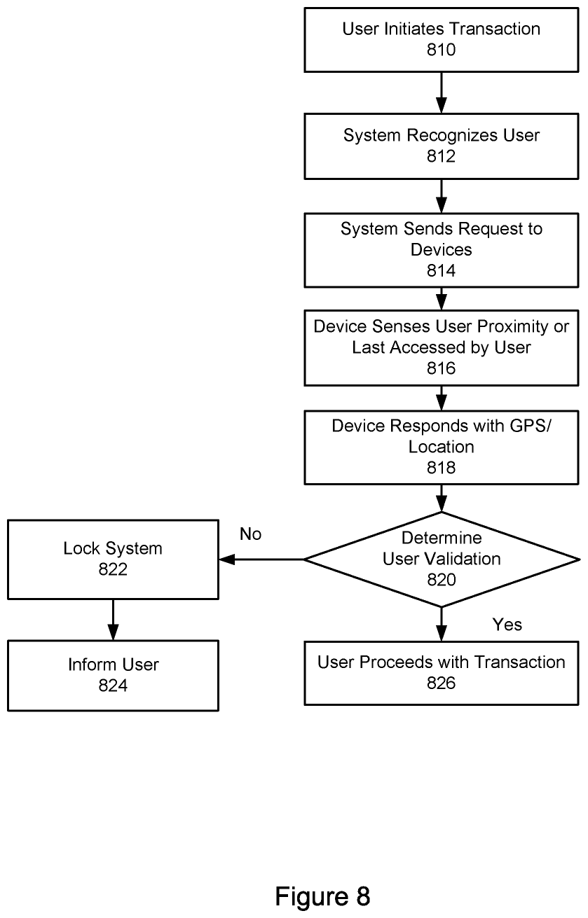

FIG. 8 is an exemplary flowchart illustrating user authentication using IoT devices, according to an embodiment of the present invention. At step 810, a user may initiate a transaction. At step 812, the system may recognize the user. At step 814, the system may send a request to one or more user IoT devices. At step 816, each device may identify user interaction. At step 818, the device may respond with user interaction data, which may include location and/or other data. At step 820, the system may determine user validation. If the user is not validated, the system may lock the transaction, at step 822, and further inform the user, at step 824 or take other action. If the user is validated, the user may proceed with the transaction at step 826. The order illustrated in FIG. 8 is merely exemplary. While the process of FIG. 8 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

Prior to the transaction, a user may activate the fraud/security feature, similar to the steps illustrated in FIG. 5.

At step 810, a user may initiate a transaction. For example, the user may enter an ATM, login to bank portal to carry out a transaction and/or initiate other interactions. The user may engage with a merchant at a merchant location. The user may also transact via an online website. Other forms of user transactions and interactions may be realized.

At step 812, the system may identify the user. This may involve obtaining or recognizing the user's identification, e.g., name, user identifier, email address, account number, etc. For example, an ATM machine or system may recognize the user (which may involve an initial level of verification). This may occur through a biometric verification, user entered credentials and/or other user identification data.

At step 814, the system may send a request to the devices to retrieve user interaction details. User interaction data may include user proximity data, location data, last interaction data, type of user interaction, etc. For example, using the user's identification, the system may request and/or retrieve details (e.g., device identifier, IP address, authentication details, etc.) of the IoT enabled devices associated with user or user account. The system may then connect to those devices via a network, e.g., Cloud connection, for user verification.

At step 816, each device may verify user interaction data in real-time. For example, a device may verify a user interaction thereby confirming a user's location at a particular point in time. User interaction data may include the last time the device was accessed by the user. Other types of user interaction data may be used to verify the user.

At step 818, the device may respond with user interaction details. This may include device location (e.g., using GPS). For example, the system may collect and/or collate details collected from the devices and use the details to determine whether the user is valid or not.

At step 820, the system may determine if the user validation is successful. If yes, the system may allow the user to proceed and carry out the transaction, at step 826.

If the user cannot be validated, the system may lock down the account for a predetermined period of time, e.g., next 30 mins, configurable time period, event based, etc., at step 822. The system may also inform the user, at step 824 and/or initiate other fraud actions.

Although the foregoing description has focused primarily on a financial institution environment, the system may be operated and maintained by other types of commercial entities who may configure the system to provide similar advantages to their customers.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

The system figures described above may include a number of servers and user communication devices, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers, modules, components illustrated in FIG. 1 may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although, the examples above have been described primarily as using a software application (“app”) downloaded onto the customer's mobile device, other embodiments of the invention can be implemented using similar technologies, such as transmission of data that is displayed using an existing web browser on the customer's mobile device.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. An authentication system comprising:
a memory that stores account data and interaction data associated with a customer;
an interface that communicates with one or more IoT devices associated with the customer;
a computer processor, coupled to the memory and the interface, programmed to:
receive a request for a financial transaction;
determine a customer identification based on a customer input;
using the customer identification, automatically identify a plurality of IoT devices associated with the customers;
identify, from the plurality of IoT devices, an authentication set of IoT devices as configured by the customer, comprising a minimum number of IoT devices based on the requested financial transaction and an IoT interaction criteria comprising one or more of a specific order for selecting the minimum number of IoT devices, a selection of a combination of IoT devices from the plurality of IoT devices that are in different physical locations, and avoidance of selecting one or more IoT devices from the plurality of IoT devices that have been designated by the customer as not part of the defined interaction as configured by the customer;
receive a customer selection of IoT devices in response to a prompt to provide the authentication set of IoT devices;
determine whether the customer selection matches the authentication set of IoT devices, including the minimum number of IoT devices as well as the IoT interaction criteria;
interpret the financial transaction request as fraudulent upon customer selection of one of the IoT devices designated as not part of the defined interaction and initiate a fraud action;
upon determining that the customer selection matches the authentication set of IoT devices, including the minimum number of IoT devices as well as the IoT interaction criteria, access details for each IoT device, the details comprising one or more of a device identifier and an internet protocol address;
connect to each of the customer selected IoT devices over a network connection, using the access details for each IoT device;
transmit a request to each of the customer selected IoT devices for customer interaction data, wherein the customer interaction data includes one or more of a customer's last log-in and a type of interaction;
receive a unique hash from each IoT device, wherein the unique hash communicates customer interaction data;
verify customer activity based on the customer interaction data;
authenticate the customer's identity based at least in part on the customer interaction data; and
authorize the financial transaction to proceed based on the customer's authenticated identity.

2. (canceled)

3. The system of claim 1, wherein the IoT devices comprise a plurality of IoT devices located at a customer's home and a second location.

4. The system of claim 3, wherein the IoT devices at the customer's home comprise home appliances and home electronics.

5. (canceled)

6. The system of claim 1, wherein the customer interaction data comprises device location data.

7. The system of claim 1, wherein user interface data comprises last interaction event.

8. The system of claim 1, wherein connecting to one or more of the selected IoT devices occurs via a cloud connection.

9. (canceled)

10. A customer authentication method, the method comprising the steps of:
receiving a request for a financial transaction;
determining, via an interface, a customer identification based on a customer input;
using the customer identification, automatically identifying, via a computer processor, a plurality of IoT devices associated with the customer;
identifying, from the plurality of IoT devices, an authentication set of IoT devices as configured by the customer, comprising a minimum number of IoT devices based on the requested financial transaction and an IoT interaction criteria comprising one or more of a specific order for selecting the minimum number of IoT devices, a selection of a combination of IoT devices from the plurality of IoT devices that are in different physical locations, and avoidance of selecting one or more IoT devices from the plurality of IoT devices that have been designated by the customer as not part of the defined interaction as configured by the customer;
receiving, via the interface, a customer selection of IoT devices in response to a prompt to provide the authentication set of IoT devices;
determining, via a computer processor, whether the customer selection matches the authentication set of IoT devices, including the minimum number of IoT devices as well as the IoT interaction criteria;
interpreting the financial transaction request as fraudulent upon customer selection of one of the IoT devices designated as not part of the defined interaction and initiate a fraud action;
upon determining that the customer selection matches the authentication set of IoT devices, including the minimum number of IoT devices as well as the IoT interaction criteria, accessing details for each IoT device, the details comprising one or more of a device identifier and an internet protocol address;
connecting, via a cloud connection, to each of the customer selected IoT devices over a network connection, using the access details for each IoT device;
transmitting, via the cloud connection, a request to each of the customer selected IoT devices for customer interaction data, wherein the customer interaction data includes one or more of a customer's last log-in and a type of interaction;
receiving a unique hash from each IoT device, wherein the unique hash communicates customer interaction data;
verifying customer activity based on the customer interaction data;
authenticating the customer's identity based at least in part on the customer interaction data; and
authorizing the financial transaction to proceed based on the customer's authenticated identity.

11. (canceled)

12. The method of claim 10, wherein the IoT devices comprise a plurality of IoT devices located at a customer's home and a second location.

13. (canceled)

14. The method of claim 10, wherein the customer interaction data comprises device location data or last interaction event.

15. An authentication system comprising:
a memory that stores and manages account data and interaction data associated with a customer;
an interface that communicates with one or more devices associated with the customer; and
a computer processor, coupled to the memory and the interface, programmed to:
receive a signal indicating an initiation of a transaction by the customer;
generate a one-time PIN for the customer;
transmit the one-time PIN to the customer; and
authenticating the transaction upon receipt of the one-time PIN from the customer.

16. The system of claim 15, wherein the transaction is an in-person transaction at a provider location.

17. The system of claim 15, wherein the computer processor is further programmed to:
identify a transaction location;
receive location data associated with the customer; and
verify a match in the transaction location and the customer location;

18. The system of claim 15, wherein the customer transaction comprises an online transaction via a website and the one-time PIN is replaced by a one-time security code.

19. The system of claim 15, wherein the one-time PIN is generated and transmitted to the customer via an application on the customer's mobile device.

20. The system of claim 15, the computer processor is further programmed to:
apply a blacklist or a whitelist that specifies valid and/or invalid transactions specific to the customer.
